(19) United States
(12) Patent Application Publication
(10) Pub. No.: US 2007/0084970 A1
(43) Pub. Date: Apr. 19, 2007

(54) Miniature kite frame

(75) Inventors: Gabriel Stephan Carlson, Encinitas, CA (US); Randal Joe, Carlsban, CA (US)

Correspondence Address: Kenneth R. Wright, Suite 400, 600 W. Broadway, San Diego, CA, 92101, US

(73) Assignee: X-Concepts, LLC

(21) Appl. No.: 11/253,124

(22) Filed: Oct. 17, 2005

(51) Int. Cl. B64C 31/06

(52) U.S. Cl. 244/153 R

(57) ABSTRACT

A miniature kite measuring less than ten inches wide and seven inches high, using a single one-piece die-cut polymer frame permanently attached to a miniature kite sail to produce the aerodynamic qualities desired for kites. The present invention also discloses a laminate frame using multiple die-cut polymer frame members where the miniature kite sail requires additional rigidity to achieve the aerodynamic qualities desired for kites.

### TECHNICAL FIELD

The present invention relates to the field of kites. More particularly, the present invention relates to a miniature kite.

### BACKGROUND AND BRIEF SUMMARY OF THE INVENTION

Known kites have been made in a large variety of forms for hundreds of years. These forms include the traditional diamond design as used by Benjamin Franklin, to animal shapes, ships, planes, and the like. These kites also typically include a tail section for stability. Miniature kites, a kite genre characterized by a wing span of typically less than ten inches and a height of less than seven inches, are also known in the art. Miniature kites offer a novelty value to the kite flyer, typically require less wind to fly than traditionally-sized kites, and their reduced size offers the benefits of easy transportation and storage without the bulk and possible disassembly required to transport and store larger kites.

Examples of miniature kites include the following: U.S. Pat. No. 5,127,611 to Payne, entitled “Miniature Kite”, discloses a miniature kite comprising a planar sheet (also referred to herein as a “sail”) supported by a frame to provide rigidity. The U.S. Pat. No. 5,127,611 kite frame is produced using multiple struts (also referred to herein as “spars”) which overlap at the center of the planar sheet and attach to the sheet at or about the sheet outer comers. At the Internet Web Site, WWW.Littlekites.com, kite designer Tom Tinney describes his version of a miniature kite. Tinney's version uses a sail material of paper or metallic mylar and multiple spars made of split bamboo or mono-filament (nylon fishing line). Both the U.S. Pat. No. 5,127,611 and Tinney kite designs require a significant amount of labor to produce the kites. The high labor content is based on the large number of components involved, including multiple spars, and the requirement that each spar be attached to the sail by hand. The significant drawback of these kites, which are representative of the state of miniature kite art, is their incompatibility with factory mass production methods, resulting in greatly increased costs of manufacture. Accordingly, it would be most desirable to have a miniature kite that overcomes these disadvantages by eliminating the multi-spar frame design by using a single section frame member, which is easily and inexpensively manufactured and attached to the kite sail. A number of advantages over prior art will become clear from the description and figures provided herein. Attention is called to the fact that the drawings are illustrative only and that variations are contemplated as part of the invention, limited only by the scope of the appended claims.

### BRIEF DESCRIPTION OF THE DRAWINGS

The invention may be further described by the following drawings:

FIG. 1 is a rear view of a miniature kite with a single section frame member.

FIG. 2 is a front view of a butterfly-shaped miniature kite.

FIG. 3 is a rear view of a butterfly-shaped miniature kite with single section frame member.

FIG. 4 is a sectional side view of a butterfly-shaped miniature kite with single section frame member.

FIG. 5 is a front view of a pentagon-shaped miniature kite.

FIG. 6 is a rear view of a pentagon-shaped miniature kite with single section frame member.

FIG. 7 is a sectional side view of a pentagon-shaped miniature kite with single section frame member.

FIG. 8 is a front view of a fan-shaped miniature kite.

FIG. 9 is a rear view of a fan-shaped miniature kite with laminate frame.

FIG. 10 is a sectional side view of a fan-shaped miniature kite with laminate frame.

FIG. 11 is a rear view of a fan-shaped miniature kite with profiled laminate frame.

FIG. 12 is a sectional side view of a fan-shaped miniature kite with profiled laminate frame.

### DETAILED DESCRIPTION OF THE INVENTION

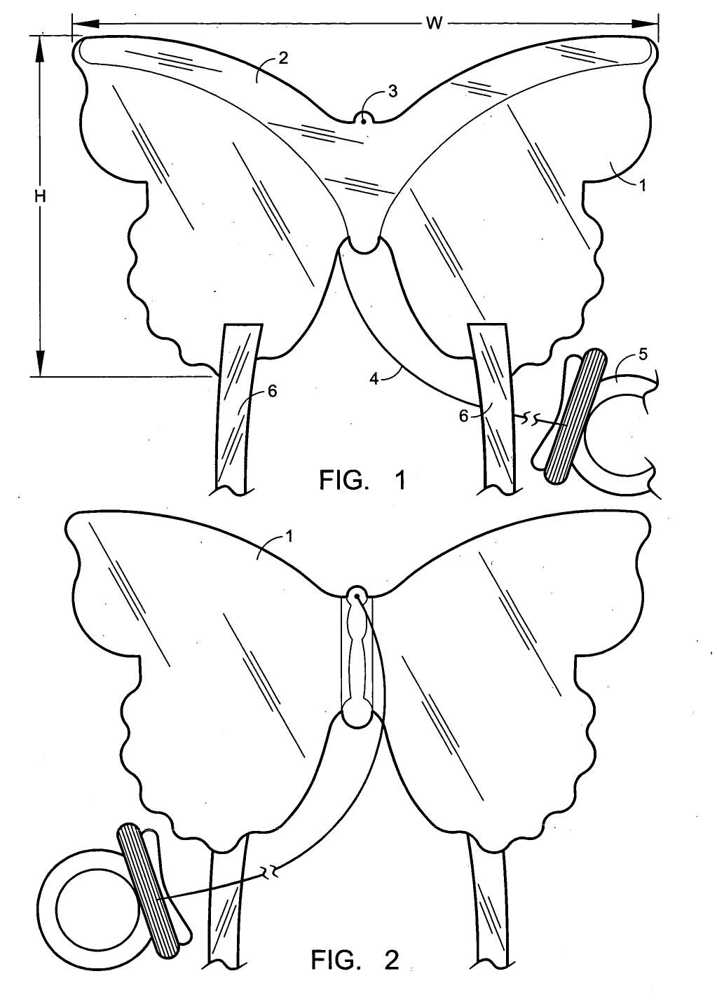

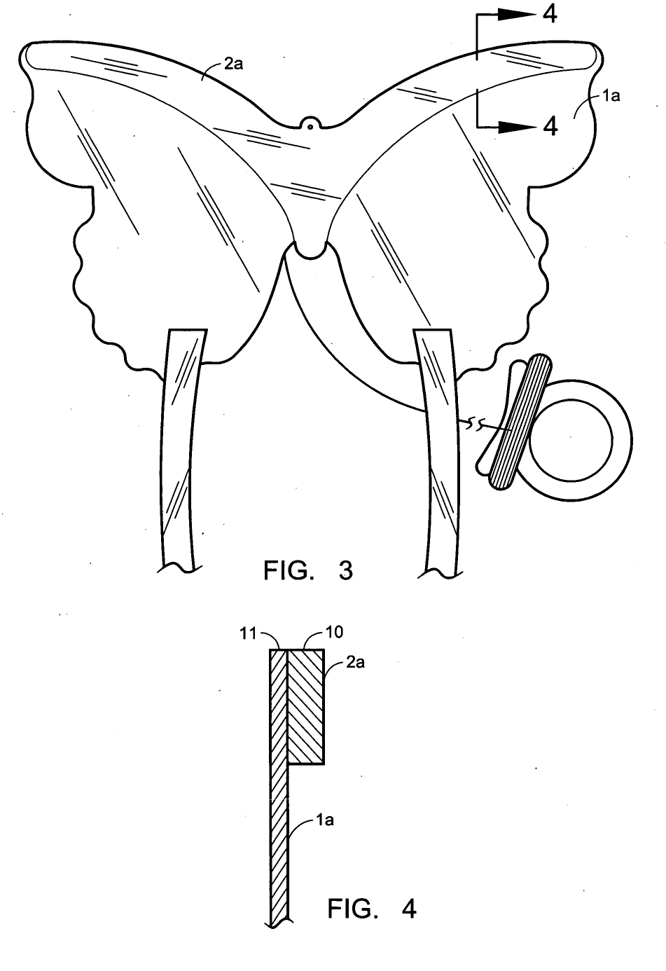

In accordance with the present invention, and referring to FIGS. 1 and 2 of the drawings, the miniature kite disclosed herein comprises a sail 1; a single section frame member 2; an attachment point 3; a flying line 4; a handle 5; and tail(s) 6. The sail dimensions are designated on FIG. 1 as “W” for width and “H” for height, where W is ten inches (10″) or less and H is seven inches (7″) or less.

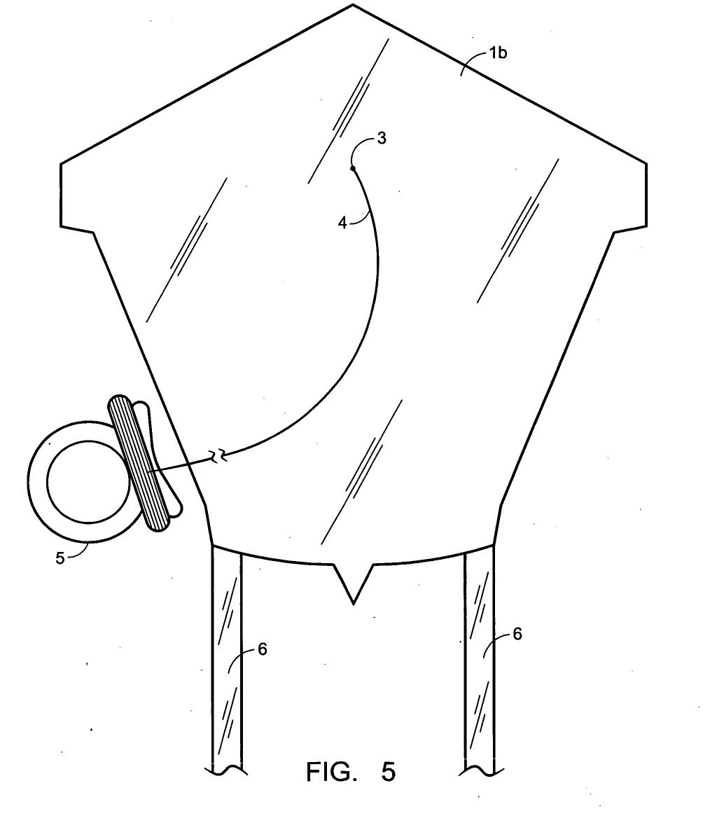

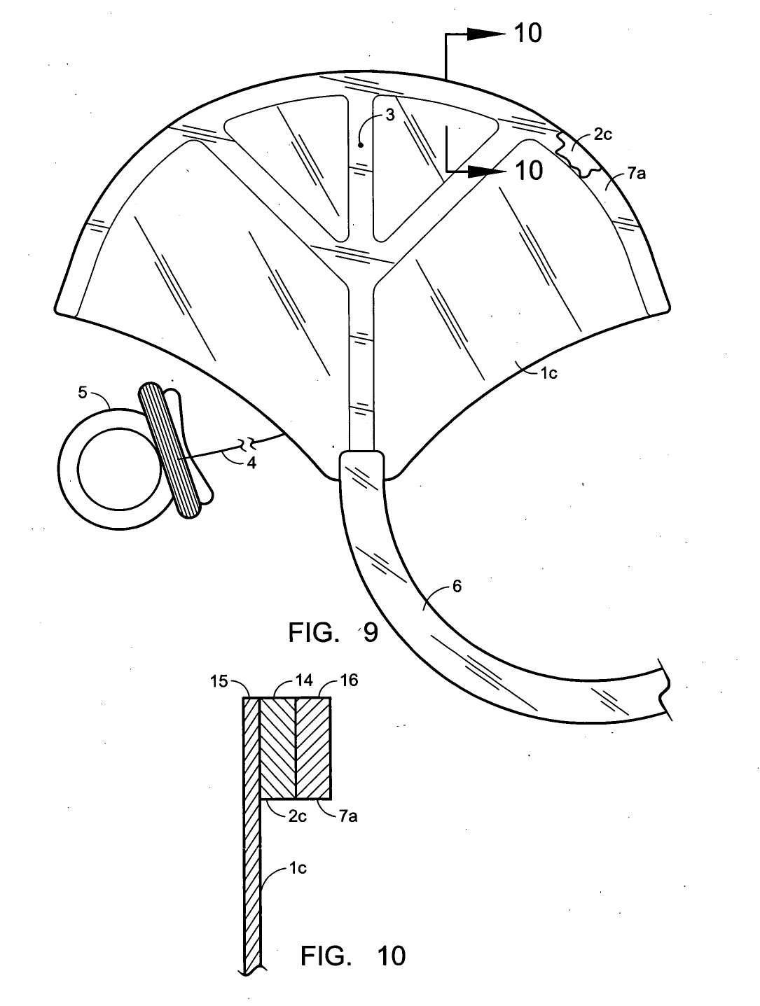

The kite sail 1 is produced from a strong and lightweight planar sheet such as polyester film (“mylar”). The kite sail 1 may also be produced from other strong and lightweight materials, such as polypropylene film, rice paper, high density polyethylene film, or low density polyethylene film. In the drawings, the sail 1a is a planar sheet in the shape of a butterfly (FIGS. 3-4), 1b a pentagon (FIGS. 5-7), and 1c a fan (FIG. 8-9, 11-12). The sail's shape can be adapted to other shapes, such as a star, an ellipse, etc., without deviating from the improvement disclosed herein. The attachment point 3 is simply the means for attachment point between the kite and the flying line 4, which in its preferred embodiment is a hole that passes through the sail 1 and frame 2. In this preferred embodiment, the flying line 4 is attached to the kite by feeding the flying line 4 first end through the attachment point 3 and tying a knot in the flying line 4 first end to prevent the flying line 4 from pulling back through the hole 3. The miniature kite disclosed herein can have more than one attachment points 3. The flying line 4 second end is attached to the handle 5.

The single section frame member 2 (also referred to herein as “frame”, “single piece frame”, and “base frame”), and examples of the frame, 2a, 2b, and 2c, in the drawings (FIGS. 3-4, 6-7, and 9-12, respectively) is of single-piece construction. The single-piece frame 2 is produced in various configurations, depending on the size and shape of the kite sail 1, and location of the attachment point(s) 3. The single-piece frame 2 is produced from one of various polymer sheet materials which provide the appropriate rigidity and which can be manufactured relatively easily and inexpensively, including polyvinyl chloride sheeting (“pvc”), polycarbonate sheeting, acrylonitrile butadiene styrene sheeting (“abs”), styrene sheeting, and rigid vinyl sheeting. In its preferred embodiment, the miniature kite frame disclosed herein is produced from pvc. The frame 2 is easily and inexpensively produced because it is die-cut from a sheet of one of the disclosed polymer sheet materials. The shape of the die used to cut the frame from the sheet determines the outer profile of the frame. The appropriate thickness of the disclosed polymer sheet material used for any particular frame design varies depending on a number of factors, including the size of the kite sail, the outer profile of the kite sail and frame, the materials used for the kite sail and frame, the relative location that the frame is attached to the sail, and the location of the attachment point.

By way of example, the butterfly-shaped sail in FIG. 3 has a “V”-shaped frame 2a which is produced by die-cutting the desired frame shape from polyvinyl chloride sheeting. The kite sail's width (“W”) is four inches (4″) and its height (“H”) is three inches (3″) (See, FIG. 1.) In FIGS. 3-4, the sail 1a is produced from 1.5 mil clear Mylar. The outer profiles of the kite sail 1a and frame 2a, and the relative location that the frame 2a is attached to the sail 1a, are described in FIGS. 3 and 4. The leading edge of the frame 10 is the same profile as the wing leading edge of the sail 11 and the frame 1a is bonded to the sail 2a at the location where the leading edges 10 and 11 correspond with one another (FIGS. 3 and 4.) The attachment point is located as shown on FIG. 4. Under the parameters described above, the pvc frame 2a used for the butterfly-shaped kite shown in FIGS. 3-4 is die-cut from 5 mil w/adhesive back pvc sheeting. Based on tests, this frame thickness provides the necessary rigidity to the sail 1a to provide the appropriate aerodynamic qualities to enable it to fly in various wind conditions.

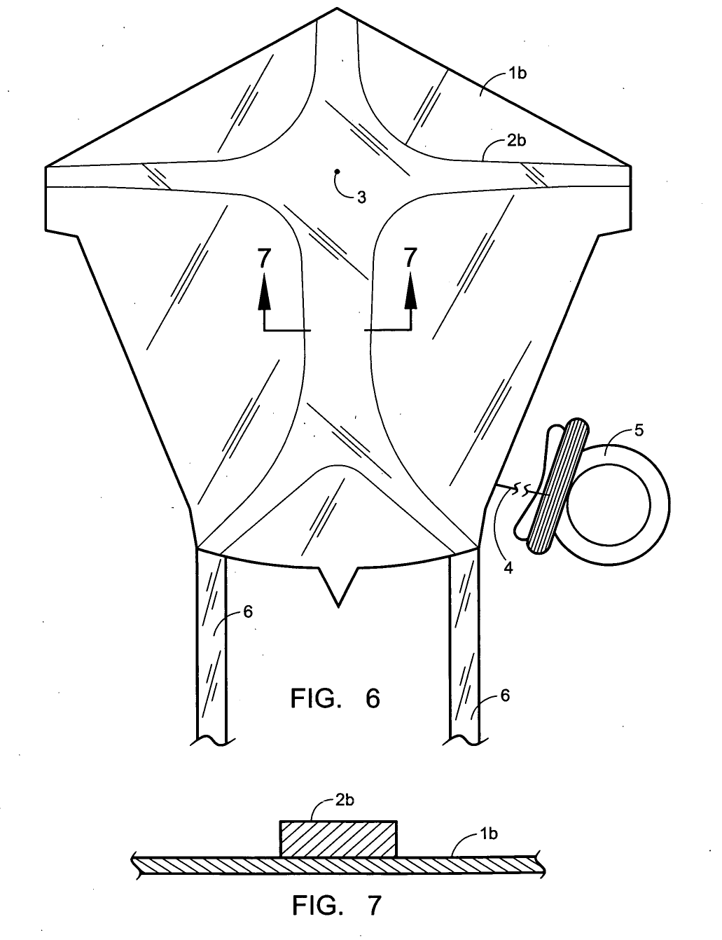

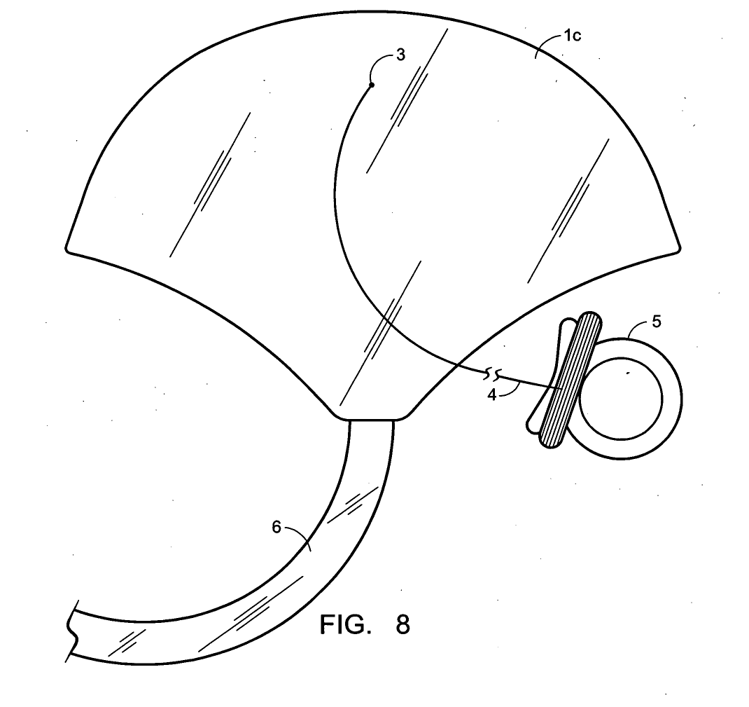

The pentagonal-shaped sail in FIGS. 5-7 has a five-point-shaped frame 2b. As in the case of the butterfly frame 1a, the pentagon frame 2b, is produced from die-cutting the desired shape from pvc sheeting. The kite sail's width (“W”) is four inches (4″) and its height (“H”) is three and 7/10 inches (3.7″) (See, FIG. 1.) In FIGS. 5-7, the sail 1b is produced from 1.5 mil clear Mylar. The frame 2b is permanently attached to the sail 1b with an adhesive. In the pentagon kite design, FIG. 6, the frame 2b is positioned on the sail 1b at the location where each end point of the frame 2b corresponds with a sail corner. The attachment point 3 is located as shown on FIG. 6. Under the parameters described above, the pvc frame 2b used for the pentagon-shaped kite shown in FIGS. 6-7 is die-cut from 5 mil w/adhesive back pvc sheeting. Based on tests, this frame thickness provides the necessary rigidity to the sail 2a to provide the appropriate aerodynamic qualities to enable it to fly in various wind conditions.

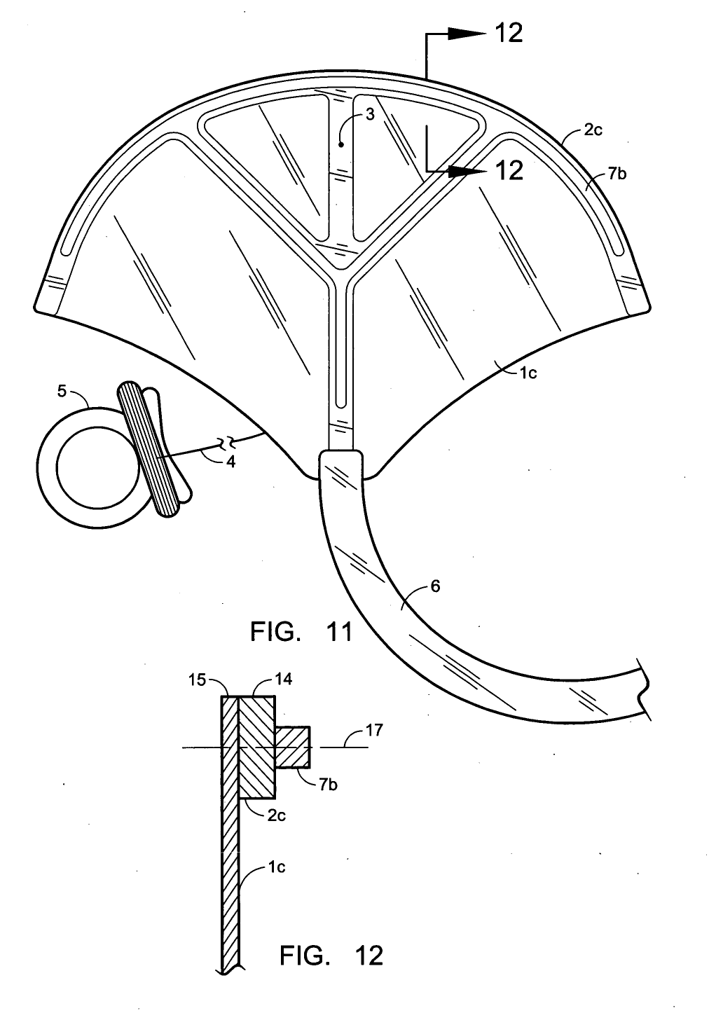

The fan-shaped sail 1c in FIGS. 8-12 has a base frame 2c produced from die-cutting the desired shape from pvc sheeting. As illustrated in FIGS. 10 and 12, the base frame 2c is laminated by permanently attaching a die-cut pvc top frame such as 7a or 7b to the base frame 2c, to create a laminate frame (“laminate frame”). The present invention discloses a laminate frame for use where the sail shape and size require greater rigidity than the single thickness pvc frame, such as frames 2a and 2b, can provide for the desired kite aerodynamic qualities. The top frame such as 7a and 7b, can be shaped to be the exact size of the base frame 2c, as shown in FIG. 10 as 7a (“top frame”), or it can be shaped in a similar configuration but reduced size to the base frame 2c, as shown in FIGS. 11 and 12 as 7b (“profiled top frame”), depending upon which aspects of the base frame 2c require additional strength as provided by the additional thickness of the laminate frame.

As can be seen from FIG. 10, the base frame 2c has a leading edge 14, the top frame 7a has a leading edge 16, and the sail 1c has a leading edge 15. The frames 2c and 7a in this particular embodiment, are positioned on the sail 1c at the location where the leading edges 14, 15, and 16, correspond with one another. FIGS. 11 and 12 show a miniature kite with a profiled laminate frame, including the relative attachment location of a profiled top frame 7b to a base frame 2c. The base frame 2c has a leading edge 14 and the sail 1c has a leading edge 15. The base frame 2c is positioned on the sail 1c at the location where the leading edges 14 and 15, correspond with one another. The profiled top frame 7b is positioned on the base frame 2c where the centerline 17 of frame 2c corresponds with the centerline 17 of frame 7b.

As before, the base frame 2c is permanently attached to the sail 1c using an adhesive. The top frames 7a and 7b are permanently attached to the base frame 2c using an adhesive. The laminate frame design disclosed herein can have more than two frames (not shown in the drawings), where a first top frame is attached to the base frame 2c as described previously, and a second top frame is attached to the first top frame, and so on, to build up the combined thickness of the kite frame.

Thus, the frame design 2 as disclosed herein can be manufactured inexpensively as it is produced as a single die-cut piece, which is then permanently attached directly to the kite sail. The single-piece frame 2 can be adapted to support other sail designs, such as triangles, stars, ellipses, etc., without deviating from the invention disclosed herein. Where the sail design so requires, the frame 2 can be a laminate frame as shown in FIGS. 9-12.

Various modifications can be made without departing from the broader scope of the present invention. The purpose of the present invention is to allow for limited independent movement of the various kite body sections to give the kite desirable flight characteristics and the illusion of movement.

What is claimed is:

1. A miniature kite comprising of:
a sail, a single section frame member, one or more attachment points, a flying line, a handle, and at least one tail, wherein said single section frame member has permanent attachment means to said sail.

2. The miniature kite of claim 1 wherein said sail is less than ten inches wide and less than seven inches high.

3. The miniature kite of claim 2 wherein said sail is polyester film, polypropylene film, rice paper, high density polyethylene film, or low density polyethylene film.

4. The miniature kite of claim 2 wherein said single section frame member is die-cut.

5. The miniature kite of claim 4 wherein said single section frame member is polyvinyl chloride sheeting, polycarbonate sheeting, acrylonitrile butadiene styrene sheeting, styrene sheeting, or rigid vinyl sheeting.

6. A miniature kite comprising of:
a sail, a laminate frame, one or more attachment points, a flying line, a handle, and at least one tail, wherein said laminate frame has permanent attachment means to said sail.

7. The miniature kite of claim 6 wherein said sail is less than ten inches wide and less than seven inches high.

8. The miniature kite of claim 7 wherein said sail is polyester film, polypropylene film, rice paper, high density polyethylene film, or low density polyethylene film.

9. The miniature kite of claim 7 wherein said laminate frame is a base frame permanently attached to one or more top frames.

10. The miniature kite of claim 9 wherein said base frame and top frames are die-cut.

11. The miniature kite of claim 10 wherein said laminate frame is polyvinyl chloride sheeting, polycarbonate sheeting, acrylonitrile butadiene styrene sheeting, styrene sheeting, or rigid vinyl sheeting.

12. A miniature kite comprising of:
a sail, a profiled laminate frame, one or more attachment points, a flying line, a handle, and at least one tail, wherein said profiled laminate frame has permanent attachment means to said sail.

13. The miniature kite of claim 12 wherein said sail is less than ten inches wide and less than seven inches high.

14. The miniature kite of claim 13 wherein said sail is polyester film, polypropylene film, rice paper, high density polyethylene film, or low density polyethylene film.

15. The miniature kite of claim 13 wherein said profiled laminate frame is produced by permanently attaching one or more profiled top frames to a base frame.

16. The miniature kite of claim 15 wherein said base and profiled top frames are die-cut.

17. The miniature kite of claim 16 wherein said profiled laminate frame is polyvinyl chloride sheeting, polycarbonate sheeting, acrylonitrile butadiene styrene sheeting, styrene sheeting, or rigid vinyl sheeting.
